(19) United States
(12) Patent Application Publication
(10) Pub. No.: US 2005/0081218 A1
(43) Pub. Date: Apr. 14, 2005

(54) Configurable simulation of virtual machine behavior

(76) Inventors: Troy Steven Acott, Beaverton, OR (US); Ross Cooper, Portland, OR (US); Miguel Sergio Grinberg, Portland, OR (US); Joanna Mason, Portland, OR (US); Stacy Anne Monday, Battle Ground, WA (US); Larry A. Westerman, Portland, OR (US)

Correspondence Address: MARGER JOHNSON & MCCOLLOM, P.C., 1030 SW MORRISON STREET, PORTLAND, OR, 97205, US

(21) Appl. No.: 10/928,681

(22) Filed: Aug. 26, 2004

Related U.S. Application Data
(60) Provisional application No. 60/498,198, filed on Aug. 26, 2003.

(51) Int. Cl. G06F 13/00

(52) U.S. Cl. 719/328

(57) ABSTRACT

The current invention describes a software methodology for simulating a virtual machine based upon a platform configuration which specifies in detail the capability of the qualitatively and quantitatively variable features of the hardware and software platforms being simulated. The configuration is used during the execution of the simulator to control the simulation process to faithfully mimic the behavior of a variety of platforms.

### CROSS-REFERENCES TO RELATED APPLICATIONS

This application claims the benefit from U.S. Provisional Patent Application No. 60/498,198 filed Aug. 26, 2003 whose contents are incorporated herein for all purposes.

### BACKGROUND OF THE INVENTION

1. Field of the Invention

The invention relates to the software simulation of the behavior of a software/hardware system when executing a user application, more specifically to the control of the details of simulation based upon user-specified configuration data.

2. Description of the Prior Art

Software simulation of hardware and software systems is a common feature in computer science. Advances in processor speed and hardware capability allow the realistic simulation of complex systems while affording significant secondary capabilities associated with the simulation. These secondary capabilities include, for example, the ability to monitor dynamic resource utilization, and to detect and signal aberrant conditions in the simulated system. Such capabilities often provide significant knowledge and understanding of the behavior of the target system which may be difficult or expensive to achieve through direct use of the target system.

For example, one common use of software simulation is in the design of computer hardware. Contemporary central processor unit (CPU) design is vastly more complex than earlier generation chips, with a single CPU containing hundreds of millions of individual transistors and gates, including on-chip memory. The successful design and implementation of such chips relies absolutely on the ability to simulate performance of the underlying hardware and micro-code design; simulation is used to iteratively perfect the design before any chips are physically created, so that hardware testing is merely the final stage of a lengthy testing process during the development effort.

When testing a CPU design, the simulation will often incorporate parameterized physical attributes of a complete system, such as the size and speed of associated random-access or read-only memory, and the capabilities of on-board or secondary memory caching systems. For efficiency, parameterization of the simulation model often involves compiling specific limits into the simulation executable; however, physical parameterization of the simulation behavior may be based upon a configuration file which is read at the start of, or during, the simulation process. In fact, file-based configuration of the simulation is a common feature in such software-based simulators. The configuration generally extends to the setting of physical characteristics of the system under simulation, such as the size and speed of memory, or the presence or absence of on-board caching.

Another parallel advance in software technology is the notion of a virtual machine, a platform-independent definition of a software or hardware/software system which performs a specific task or set of tasks according to a defined protocol. The value of a virtual machine is that variant hardware and/or software implementations can be made of a virtual machine, each supplying the specified behavior. An important example of platform-independent software in use today is the Java software language developed by Sun Microsystems. The accompanying Java Virtual Machine (JVM) provides a platform upon which any Java program can be executed with predictable behavior. Different implementations of the JVM may vary in available memory or processor speed, for example, but within these limitations, the behavior of the JVM will be as specified.

The value and advantage of the Java language and the JVM have been appreciated in the context of providing interactive television (ITV) services. The development of ITV services has been hampered in the past due to the plethora of hardware and software platforms in use in the broadcast, satellite and cable distribution markets. Since early analog cable and digital satellite receivers were subsidized by distributors, the emphasis was on cost reduction and hardware simplification, leading to a proliferation of disparate units. These receivers, often called set-top boxes (STBs), are made by a variety of manufacturers and have become a commodity item. For the same reasons, a variety of operating systems, often called middlewares, were introduced into the digital television marketplace.

Counteracting this trend in recent years, broadcasters and distributors have begun to collaborate on developing common standards for broadcast receiver/decoders, and the Java language has served as a foundation for the modern Digital Video Broadcasting—Multimedia Home Platform (DVB-MHP) and Open Cable Applications Platform (OCAP) middleware standards. Future digital receivers may support one or both of these similar standards; this standardization is expected to expand the market for and simplify the development of interactive television applications and services.

However, the market today is characterized by the presence of millions of legacy receivers which are not capable of executing the DVB-MHP or OCAP standard middleware. In order to support these older, less-capable platforms, a targeted, optimized virtual machine specification has been developed by the assignee of the present invention, which in conjunction with a streamlined ITV-specific application language (TVScript), thus affording many of the advantages of the JVM while still executing on low-end receivers. The TVScript language provides a limited set of organizational, graphics and functional elements which can be utilized to implement a broad range of useful and compelling ITV applications. The virtual machine developed by applicant to interpret compiled TVScript applications, called the on-Q client, can be ported to a variety of legacy and future STBs.

The concepts of virtual machine simulation and configurable virtual machines are not novel. For instance, the IBM J9 virtual machine is a configurable implementation of the Java virtual machine (http://www-3.ibm.com/software/wireless/wce), with selectable control over supported functions, memory usage, stack size, and other fixed hardware and software features. However, this configuration is performed at the source level, so that each configuration specification results in a unique and distinct version of the executable virtual machine.

A challenge with porting virtual machines, such as on-Q client, in the ITV arena is the enormous span of capabilities of the underlying STB hardware and software. Even for a broadcast system utilizing a common middleware, the actual STBs may represent a variety of CPUs, memory footprints, and display subsystems, so that a single unifying set of performance and behavior characteristics cannot usefully be defined. Reducing the behavior of the virtual machine to only those capabilities and features common to all platforms would result in a useless abstraction. Instead, the approach taken with the on-Q Client virtual machine was to define a set of ‘default’ or ‘preferred’ behaviors, then stipulate the ways in which specific platforms might deviate from those behaviors.

A simple example of such variant behavior is the depth of color for graphical elements. Many STBs support 256-color palettes for graphical display, while some support only 16-color images. Thus, the preferred behavior is for 256-color support, but reduced-color images are acceptable and can be displayed. A more advanced example is the support of transparency: The preferred behavior of graphical objects like buttons and images includes the capability for graduated pixel transparency. Few STBs actually support this advanced capability, so acceptable alternatives include support for a limited set of transparencies (e.g. opaque, semi-transparent, and transparent), or a single non-opaque value of transparency which is substituted for any intermediate value.

The variability of capability and performance among STBs presents a special challenge to proper simulation of the behavior of the on-Q Client virtual machine. In addition to typical quantitative hardware variables such as processor speed and memory size, the virtual machine simulation must take into account significant variation in the presence and capability of a number of other aspects of software and hardware performance. A common solution to this problem of variability is the provision of multiple targeted simulators, or the creation of multiple interchangeable libraries of functionality, among which the simulator might select in a configuration step prior to performing the simulation. However, neither of these solutions is appropriate when the desire is to have a single simulator which can be dynamically configured, and is capable of simulating a vast number of user-selectable combinations of functionality settings.

Accordingly, the need remains for a simulator that overcomes these drawbacks in the prior art.

### SUMMARY OF THE INVENTION

The current invention describes a software methodology for simulating a virtual machine based upon a platform configuration which specifies in detail the capability of the qualitatively and quantitatively variable features of the hardware and software platforms being simulated. The configuration is used during the execution of the simulator to control the simulation process to faithfully mimic the behavior of a variety of platforms.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram showing a comparison of STB and PC environments for on-Q Client virtual machine implemented according to a preferred embodiment of the present invention.

FIG. 2 is a table showing sample configuration data for set-top boxes according to one implementation of the invention.

### DETAILED DESCRIPTION

The following description relates the invention to applicant's TVScript language but those knowledgeable in the art would appreciate that the invention can be expanded to work using other such computer programming languages and methods.

The TVScript language is an object-based software language developed for use in creating interactive television (ITV) applications. The language comprises a small set of objects, which fall into three classes.

Organizational objects, including Global, Screen, and Overlay, provide grouping capabilities for subordinate objects.

Graphical objects, including Button, CheckBox, Image, Rectangle, TextBox, and VideoStill, provide graphical display capabilities. The StandbyAnimation and StandbyScreen objects are used in the initial stages of an application to provide immediate visual feedback during the load delay.

Functional objects provide useful functionality for the application, including IndexList, StateTable, Table, Timer, and Transaction objects.

The TVScript language specification stipulates the properties and functions associated with each of these objects; the language also includes system functions, and the option for user-defined custom functions. Functions, both pre-defined and custom, can be used as event handlers for the various viewer- and system-driven events which can occur during the execution of an application.

For many aspects of the TVScript language specification, specific note is taken of the potential differences in performance among the divergent STBs on which the TVScript interpreter, on-Q Client, may execute. For each of such differences, alternate behaviors are specified where appropriate. For example, the properties of the Screen object include settings for video positioning and scaling. Horizontal and vertical scaling factors can be set in one-percent increments from 1 to 1000 percent inclusive. However, on any particular STB, scaling may or may not be supported; when supported, the hardware may only support a fixed set of scaling values. On such hardware systems, scaling is performed at the supported value which is ‘closest’ to that set by the TVScript code. An on-Q Simulator, which provides simulation capability for debugging, testing and previewing TVScript applications, must faithfully reproduce all these variations in performance.

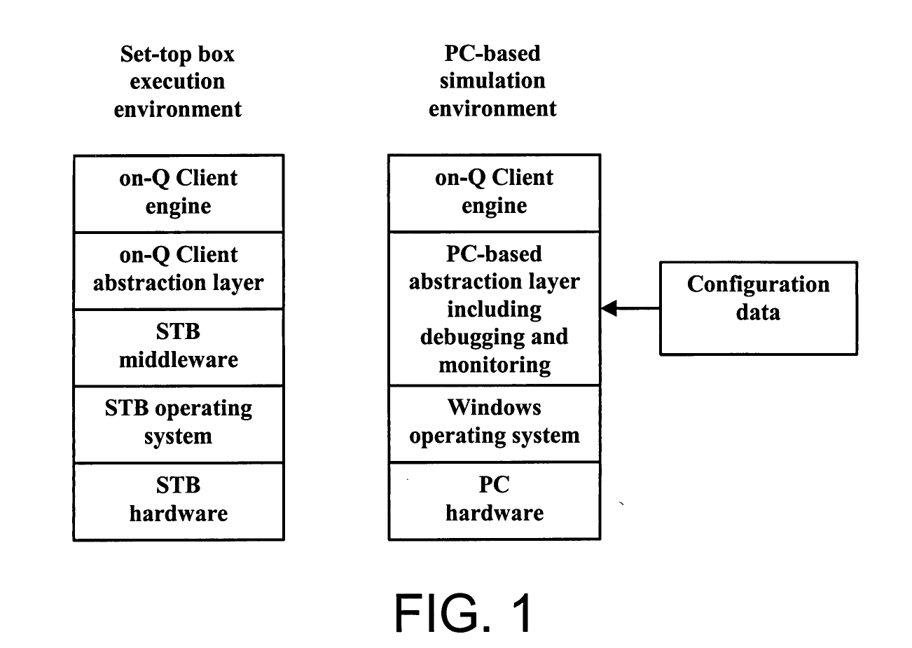

For simplicity, on-Q Client is structured in two pieces. One component, the engine, is a platform-independent module which provides the basic functionality of the virtual machine, reading the various input modules which comprise the interpretable application code and associated resource modules; the other component, the abstraction layer, is a platform-dependent module which translates the abstract requirements of the engine to the specific middleware functionality provided on the STB. When porting on-Q Client from one platform to another, only the abstraction layer need change. When simulating the performance of on-Q Client on a development personal computer workstation, the engine code is used intact, while on-Q Simulator incorporates a special abstraction layer designed to interface to the underlying Windows operating system functionality, including graphics and storage capabilities. FIG. 1 shows the relationship between the STB organization of on-Q Client and the PC-based on-Q Simulator.

The interface between the engine layer and the abstraction layer is embodied in an application programming interface (API) which contains a relatively small number of platform-independent functions. All TVScript applications interpreted by on-Q Client derive functionality through this API. Platform variations derive from differences in response of the abstraction layer code to calls made through the API. Thus, simulation of these variations can be accomplished in the PC environment solely within the abstraction layer. In the current invention, configuration data are used to determine the appropriate response of on-Q Simulator to API calls from the engine.

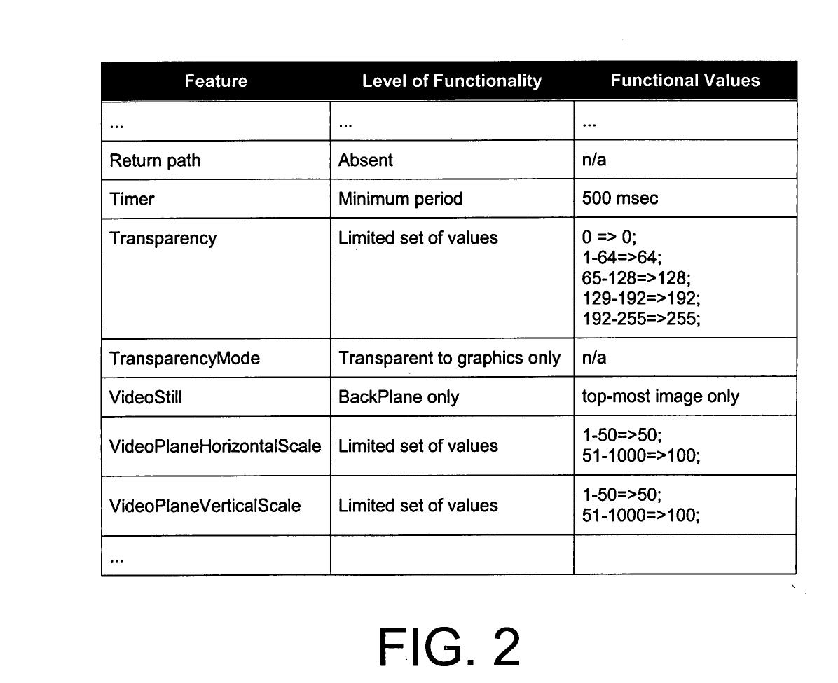

A stylized excerpt from the configuration data is shown in FIG. 2. Configuration data stipulate the specifics of any aspect of STB behavior which may vary from the ‘preferred’ specified behavior. FIG. 2 shows examples of the several types of variations which arise. The first row determines the presence or absence of return-path functionality. The TVScript Transaction object provides for communication via a return path; such communication may occur over the cable which supplies the video signal, or for a satellite or broadcast environment, through a dial-up telephone modem. Not all STBs provide for such capability, so the configuration file indicates whether the return path is present.

The second entry row defines the minimum supported timer period, in this case 500 msec. This is greater than the nominal minimum of 30 msec.

The next entry row in the configuration data defines the hardware performance for pixel transparency of graphical objects. In this case, only a limited set of transparency values is supported, namely fully opaque (0), fully transparent (255), and three intermediate values (64, 128, and 192). The mapping of discrete integer transparency values for the valid range from 0 to 255 is specified.

The fourth entry row stipulates the transparency characteristics of graphical pixels. In this case, transparent pixels show through the contents of underlying graphics objects, rather than being transparent to the underlying video if present.

The next entry row describes the capability for displaying video still (full-color) images. Such images are displayed using the video display, rather than graphics, display hardware; for this configuration, only one such video image can be shown, and it is shown utilizing back plane hardware which is distinct from the display of streaming video.

The sixth and seventh entry rows describe the capability for scaling streaming video content. In this configuration, scaling to half-screen width and height is the only supported scaling mode, so the range of values from 1 to 1000 percent is mapped to these two values.

The configuration data will also include quantification of certain physical parameters of the STB, including for example memory size, color palette size, color depth, and so forth.

A complete configuration file may include details of the following types:

Presence or absence of a functionality—for example, return path;

Physical size or extent of a feature—for example, memory size;

Characteristics of a display or functional feature—for example, semi-transparency support; and

Mapping of TVScript property values to supported middleware/hardware values—for example, horizontal scaling values.

During the simulation, the configuration data are used to control the response of on-Q Simulator to the interpretation of the TVScript application. For instance, should a TVScript function set the values for scaling of streaming video presented on the screen, the Simulator display would determine the realizable behavior of the underlying configuration, then modify the display on the PC to reflect that limitation.

In the preferred embodiment of this invention, the configuration file limits are utilized in the simulation to determine the boundaries of execution for the virtual machine and the TVScript application. When such a boundary is reached, say the memory size of the STB, the virtual machine may report a failure on a memory allocation request.

However, there are certain circumstances in which the user of the Simulator might wish to ignore or override limitations of the underlying STB, while being informed of those limitations. To support such cases, in an alternative embodiment the configuration data are extended to include an additional Boolean flag for each entry in the configuration. When this Boolean ‘ignore’ flag is true, the Simulator will determine whether the TVScript application attempts to utilize a language feature or behavior which is not supported by the underlying STB. When such is the case, the Simulator will display or log a warning message to that effect, while continuing to provide the ‘preferred’ behavior defined for that language feature or behavior. Such a feature might be useful in the case, for example, where the underlying STB can only support a limited number of Timer objects being simultaneously active. The user of the Simulator may wish to be warned about violation of this limit, while also being able to view how the application would function were that limit not imposed. This capability is particularly useful when the limitation captured by the configuration data is a ‘soft’ limit as opposed to a ‘hard’ limit. For instance, a platform with limited physical memory may support virtual memory; the use of virtual memory may result in slower response, while not prohibiting continuing execution. If the physical memory limit were exceeded only in unusual or rare circumstances, such a violation of the configuration limit may be acceptable.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A simulator for use in testing the operation of a simulated computer on which computer software applications are intended to be operated, the simulator comprising computer instructions stored in a memory and operable on a microprocessor in association with a display and comprising:
a platform-independent virtual machine engine capable of operating the computer software applications thereon;
a platform-dependent abstraction layer operable on the microprocessor in association with the virtual machine engine, said abstraction layer operating to translate the abstract requirements of the engine to a specific functionality provided by the simulated computer; and
an interface between the virtual machine engine and the abstraction layer embodied in an application programming interface (API) which includes a relatively small number of platform-independent functions available through the computer software applications.

2. The simulator of claim 1, wherein the simulator patterns operation of the computer software applications on the simulated computer to differences in response of the abstraction layer code to calls made through the API, the simulator further including configuration data, stored in memory, and used to determine the appropriate response of the simulator to API calls from the engine.

3. The simulator of claim 2, the configuration data including the presence or absence of a functionality.

4. The simulator of claim 3, the configuration data including the present or absence of the function “return path.”

5. The simulator of claim 2, the configuration data including the physical size or extent of a feature.

6. The simulator of claim 5, the configuration data including the memory size of the simulated computer.

7. The simulator of claim 2, the configuration data including the display characteristics of the simulated computer.

8. The simulator of claim 7, the configuration data including whether semi-transparency is supported by the simulated computer.

9. The simulator of claim 7, the configuration data including scaling values for streaming video provided to the simulated computer.

10. The simulator of claim 2, the configuration data including a mapping of application property values to supported middleware/hardware values.

11. The simulator of claim 9, the configuration data including horizontal scaling values of the simulated computer.

12. The simulator of claim 2, the configuration data utilized by the simulator to determine boundaries of execution and report a failure when the boundary is exceeded by operation of the application on the simulator.

13. The simulator of claim 2, further including a Boolean ignore flag for each configuration data, said ignore flag operable on the simulator to display or log a warning message responsive to an incompatibility between a feature of the application and the simulated computer unable to support that feature.

14. The simulator of claim 13, the simulator operating a preferred behavior designated by the application in association with display or log of the warning message so that one can view how the application would function were a soft limit of the feature incompatibility not imposed.

15. The simulator of claim 1, wherein the computer is a set top box (STB).

16. The simulator of claim 15, wherein the computer software applications are interactive television applications.

17. The simulator of claim 16, wherein the simulator patterns operation of the interactive television applications on the set top box to differences in response of the abstraction layer code to calls made through the API, the simulator further including configuration data, stored in memory, and used to determine the appropriate response of the simulator to API calls from the engine.

18. The simulator of claim 17, the configuration data including the presence or absence of a functionality.

19. The simulator of claim 18, the configuration data including the present or absence of the function “return path.”

20. The simulator of claim 17, the configuration data including the physical size or extent of a feature.

21. The simulator of claim 20, the configuration data including the memory size of STB.

22. The simulator of claim 17, the configuration data including the display characteristics of the STB.

23. The simulator of claim 22, the configuration data including whether semi-transparency is supported by the STB.

24. The simulator of claim 23, the configuration data including scaling values for streaming video provided to the STB.

25. The simulator of claim 17, the configuration data including a mapping of application property values to supported middleware/hardware values.

26. The simulator of claim 24, the configuration data including horizontal scaling values of the STB.

27. The simulator of claim 17, the configuration data utilized by the simulator to determine boundaries of execution and report a failure when the boundary is exceeded by operation of the application on the simulator.

28. The simulator of claim 17, further including a Boolean ignore flag for each configuration data, said ignore flag operable on the simulator to display or log a warning message responsive to an incompatibility between a feature of the application and the STB unable to support that feature.

29. The simulator of claim 28, the simulator operating a preferred behavior designated by the application in association with display or log of the warning message so that one can view how the application would function were a soft limit of the feature incompatibility not imposed.
